(19) United States
(12) Patent Application Publication
(10) Pub. No.: US 2017/0158148 A1
(43) Pub. Date: Jun. 8, 2017

(54) LICENSE PLATE HANDLE BRACKET

(71) Applicant: Cruiser Accessories, LLC., Monument, CO (US)

(72) Inventors: Todd Spencer, Monument, CO (US); Timothy Nevin, Monument, CO (US); Dave Heberly, Monument, CO (US)

(21) Appl. No.: 14/962,898

(22) Filed: Dec. 8, 2015

(51) Int. Cl. B60R 13/10; F16M 13/06

(52) U.S. Cl. CPC B60R 13/105; F16M 13/06

(57) ABSTRACT

A license plate handle bracket is provided herein, The license plate handle bracket may be configured for attaching with a license plate to a vehicle trunk lid. The bracket may include a backer and an extension. The backer may be configured to receive a license plate and mount onto a vehicle trunk lid. The extension may point outwardly from the backer. The extension may extend a sufficient distance and in a direction that forms a finger-engagement feature beyond a thickness of the license plate. The extension may form a sufficiently strong platform for a user to engage and apply a sufficient force to the extension in order to manipulate the trunk lid.

### TECHNICAL FIELD

Disclosure herein is a bracket having a handle; more particularly, the bracket is a. license plate backer that provides a handle extending there from suitable to utilize as a compartment handle or, more particularly, a trunk handle.

### BACKGROUND

Many vehicle owners go to great lengths to protect their vehicles paint and external hardware. Manipulation of a vehicles trunk sometimes results in frequent contact with the paint or other external hardware. Additionally, some vehicle owners seek out vehicles with smooth lines and surfaces for their aesthetic appeal. One way to do this is to provide a vehicle with limited or no external features such as handles or protrusions that extend from the external surfaces of the vehicle. Such features are common at the accesses to internal compartments of the vehicle such as the trunk. A drawback to removing these features is that there is nothing available on the panel to apply a desired force to manipulate (i.e. lift or lower) the panels. Thus the paint surface is used, which can cause undue wear.

Despite the desire to provide a clean look on a vehicle, due to state laws most vehicles have a state-required license plate attached to the rear end of the vehicle. Many automobile owners still desire to provide an attractive appearance to their vehicle in spite of the burden of attaching a state-issued license plate. Improved devices that overcome these, as well as other shortcomings, are desirable.

### SUMMARY

A license plate handle bracket is provided herein. The license plate handle bracket disclosed herein leverages the license plate requirement to provide an external feature for opening or closing the rear access panel of the vehicle. The bracket may be configured for attaching with a license plate to a vehicle trunk lid. The bracket may include a backer and an extension. The backer may be configured to receive a license plate and or license plate frame and mount onto a vehicle trunk lid. The extension may point outwardly from the backer beyond the license plate and or the license plate frame. The extension may extend a sufficient distance and in a direction that forms a finger-engagement feature beyond a thickness of the license plate. The extension may form a sufficiently strong platform for a user to engage and apply a sufficient force to the extension in order to manipulate the trunk lid.

In accordance with various embodiments, the extension may be contiguously formed with the backer. The extension may be cantilevered from one edge of the backer. The extension may include a first wall having a sufficient size such that a user is able to engage the user's fingers on the first wall and apply a sufficient force in order to manipulate the trunk lid. The first wall may be perpendicular to the backer.

The first wall may define a portion of a first recess that is concave toward the direction the backer extends from the extension. The first wall may include a return wall that forms a portion of the first recess, with the return wall extending from the first wall in generally the same direction as the backer extends from the first wall. The extension may include a second wall connected to the first wall at the return waif

The second wall may be sized such that a user is able to engage the user's fingers on the second wall in order to apply a sufficient force to manipulate the trunk lid. The second wall may be perpendicular to the backer. The second wall may define a portion of a second recess that is concave in the opposite direction of the concavity of the first recess. The second wall may include a return lip that forms a portion of the recess, with the return lip extending from the second wall in a direction forming the concavity of recess. The first recess and the second recess may be positioned in opposite directions such that the first recess can receive a user's fingers on one side of the extension and the second recess can receive a user's finger on the other side of the extension.

The first wall includes a first aperture there through of sufficient size to drain water from the first recess. The second wall includes a second aperture there through of sufficient size to drain water from the second recess. The backer may include one or more connection elements positioned on the backer and configured to position the license plate relative to the backer. The extension may be positioned relative to the backer such that when the license plate is attached to the backer, the extension is repositionable either above or below the license plate. The one or more connection elements may be defined by a plurality of apertures that are positioned to receive a fastener from a plurality of license plate connecting apertures. The backer and the extension are formed from a polycarbonate material. The polycarbonate material may be a clear or translucent such that the backer and the extension have limited visual obstruction of the license plate, license plate frame, or the trunk lid.

### BRIEF DESCRIPTION OF THE DRAWINGS

The drawing figures depict one or more implementations in accordance with the present concepts, by way of example only, not by way of limitations. In the figures, like reference numerals refer to the same or similar elements,

FIG. 1 is a perspective view of a vehicle having a license plate and a handle bracket in accordance with an exemplary embodiment of the disclosure provided herein;

FIG. 2 is a perspective exploded view of the license plate and the handle bracket assembly of FIG. 1;

FIG. 3 is a side view of the bracket of FIG. 1;

FIG. 4 is a detailed side view of the bracket of Fig. I shown at detail 4-4 shown in FIG. 3;

FIG. 5 is a top view of the bracket of FIG. 1; and

FIG. 6 is a rear view of the bracket of Fig. I.

### DETAILED DESCRIPTION

As disclosed herein, a bracket may be positioned relative to a license plate such that an extension from the bracket is positioned proximal to the license plate. The relative position of the extension and the license plate allows the two components to aesthetically merge. The extension may be accessible to a user's hand or fingers and may be assembled together with a license plate and attached to a vehicle. The bracket may specifically be attached to a compartment having a movable panel configured to enclose the compartment, such as a vehicle trunk. As many vehicles lack any handle, grip, or other component for manipulating the vehicle's trunk lid (or the vehicle user desires not to use the available component), the bracket extension may allow the vehicle operator to manipulate the trunk lid or other compartment closure panel. Even on vehicles that may have hardware for manipulating the vehicle's access panels, the extension may provide an alternative replicable feature to allow an operator to contact so that the vehicle's hardware does not undergo the constant use and wear that the extension does. This may extend the life and aesthetics of the vehicle's hardware or paint at the expense of the much easier to replace bracket, because by using the bracket the user will not have to place a. hand on any painted surface or hardware on the trunk lid and will minimize the scratching and rubbing of the painted surface and hardware on the vehicle.

In the following description, numerous specific details are set forth in order to provide a thorough understanding of the concepts and subject matter set forth herein. It will be apparent to one skilled in the art that the concepts described herein may be practiced in accordance with various combinations that may include only a few of the attributes described or may include many or all of the attributes described. Some well-known methods and structures have not been set forth in order not to unnecessarily obscure the description of the present invention.

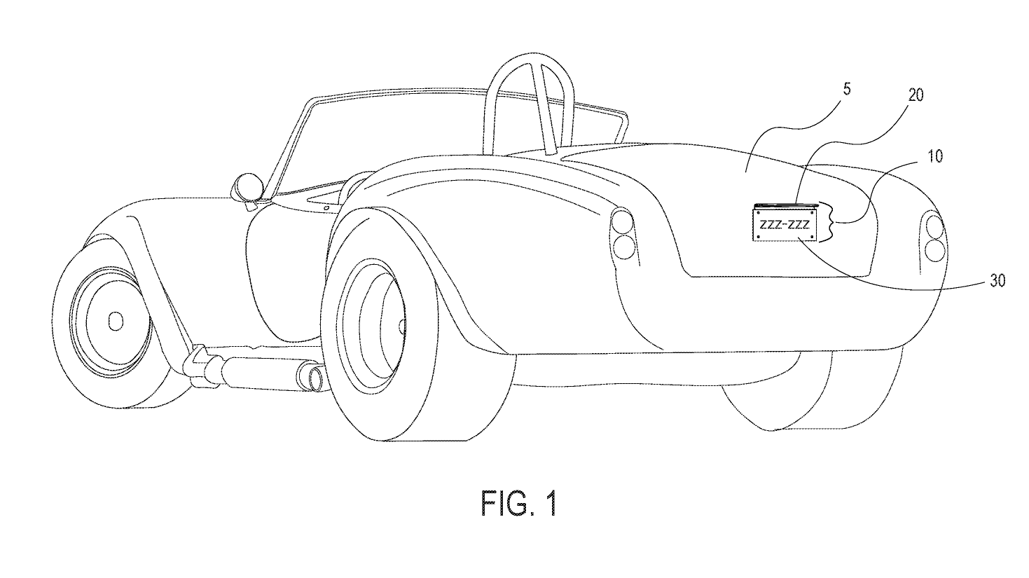

As illustrated in FIG. 1, an exemplary vehicle is shown with a compartment access panel 5. The compartment access panel 5 may be a vehicle trunk lid as shown in the example; however, other access compartments are contemplated herein as well. In accordance with various embodiments, a license plate handle bracket assembly 10 may be fastened to the vehicle, and specifically, the access panel 5 of the vehicle. The license plate handle bracket assembly 10 may utilize fasteners that under other circumstances would merely be used to attach the license plate 30 to the vehicle. However, as shown herein the license plate handle bracket assembly 10 may be attached at the license plate connection location via hardware used to connect the license plate to the vehicle.

The license plate handle bracket assembly 10 may include the license plate 30 and a bracket 20. As indicated above, the bracket 20 may be configured to operate as an engagement feature to manipulate the access panel 5. The example access panel 5 is shown having no handles, protrusions, or other features operable to lift the panel 5. Thus, the inclusion of an engagement feature on the bracket 20 may operate as the primary engagement feature for manipulating the panel 5. In some instances, however, the panel 5 may have various handles, protrusions, or other features but may none-the-less utilize the bracket 20 in order to reduce wear and tear on the hardware or the painted surfaces of the panel 5 when opening or closing the access panel.

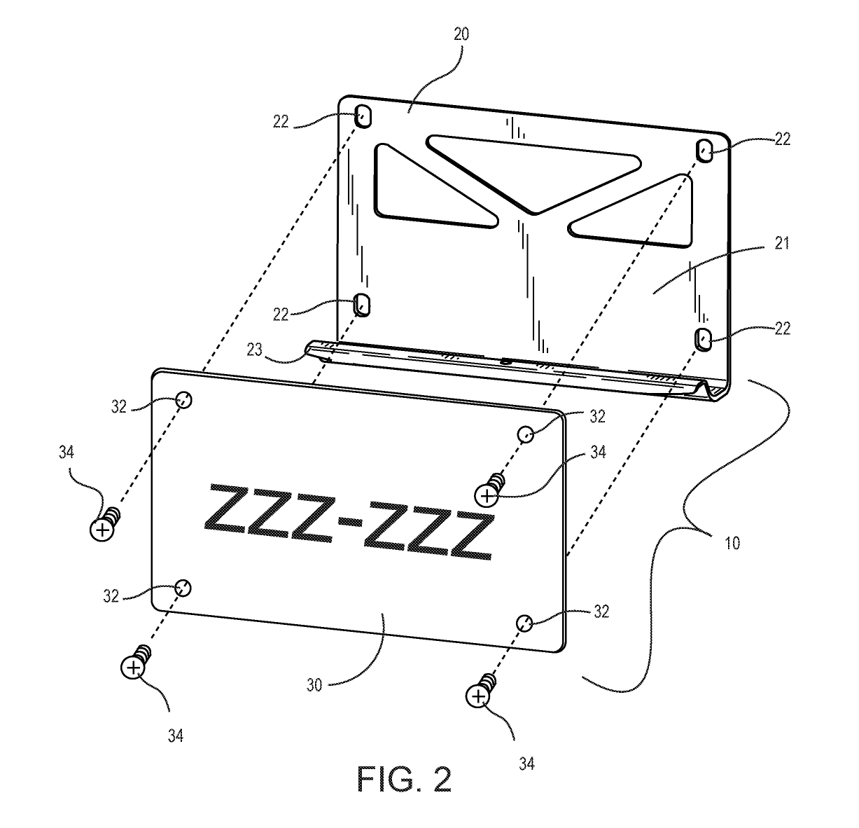

As illustrated in FIG. 2, the license plate 30 may be assembled with the bracket 20. Generally, license plates are standardized throughout any individual country. In the US, all license plates have standardized geometric characteristics only varying by graphical characteristics. Accordingly, a person of ordinary skill in the art may adopt the concepts described herein to any license plate in any country.

The bracket 20 may include a backer 21. The backer 21 may be any structure that operably positions the bracket 20 relative to the license plate 30 when mounted on a vehicle, As shown in FIGS. 2 and 6, the backer 21 may be a flat plate for mating with the generally flat surface of license plate 30. In embodiments, the backer may be a part of a license plate frame or some other similar support structure for the license plate. For example, the license plate 30 may mount directly to and fixedly attach to the backer 21. In such an embodiment, the backer may include connection features 22 that retain the license plate. These connection features may include clamps, adhesives, brackets, or hardware such as bolts or nuts. In other embodiments such as the one depicted in FIGS. 1 and 2, the backer 21 may be sandwiched between the license plate 30 and the panel 5 when installed on a vehicle.

In various embodiments, the backer 21 may include one or more connecting features 22. As indicated above, the connecting features 22 may mount the backer 21 to the license plate 30. Alternatively, or additionally, the connecting features 22 may be utilized to mount the backer 21 to the vehicle. As shown in FIG. 2, the connecting features 22 may be apertures that operably receive fasteners 34. The license plate may have a plurality of connecting features 32. These connecting features 32 may be apertures which are standardized with respect to position so that car manufacturers can provide mounting features for the license plates. The fasteners 34 may pass through the connecting features 32 (e.g., apertures) and then pass through connecting features 22 (e.g., apertures) to fasten both the license plate 30 and the backer 21 to the vehicle as shown for example in FIG. 1. The connecting features 22 may be positioned to match the connecting features 32 such that the backer 21 and the license plate 30 may align along these features 22, 32. Utilizing the features 22, 32 together, the bracket 20 may be positioned relative to the license plate 30.

The bracket 20 may also include an extension member 23. The extension member 23 may extend away from the backer 2.1. The extension member 23 may extend in the same direction as and beyond the license plate 30 relative to where the license plate 30 is assembled with the bracket 20. The extension member 23 may also by sufficiently long to extend past a license plate bracket and allow a user to reach, grab, or otherwise manipulate the extension member 23. The connecting features 22 may be positioned on backer 21 such that the license plate 30 may be positioned relative to the extension member 23 such that the extension member 23 can pass either above the plate 30 or below the plate 30 when assembled together with the bracket 20. FIG. 1 illustrates an example with the extension member 23 positioned above the license plate 30 and FIG. 2 illustrates an example with the extension member 23 positioned below the license plate 30.

The extension member 23 may be structured such that it has sufficient strength to manipulate the access panel 5 of a vehicle (e.g., open or close the panel). The extension member 23 may also be sized such that at least one or more fingers can engage the extension member sufficiently so that a user can manipulate the access panel 5 using only that at least one or more fingers. In some embodiments, the extension member 23 is sized such that four fingers can engage the extension member 23. In some embodiments, the extension member 23 may be a device that the entire hand can grasp. As used herein, the term handle may apply to any member that can be engaged by an entire hand or only one finger. While the extension member 23 is shown as a thin-walled material extending from the backer 21, it will be appreciated that this is merely an example and the extension member 23 may be any shape or structure including a cylindrical shape or a shape similar to other trunk handles known on the market.

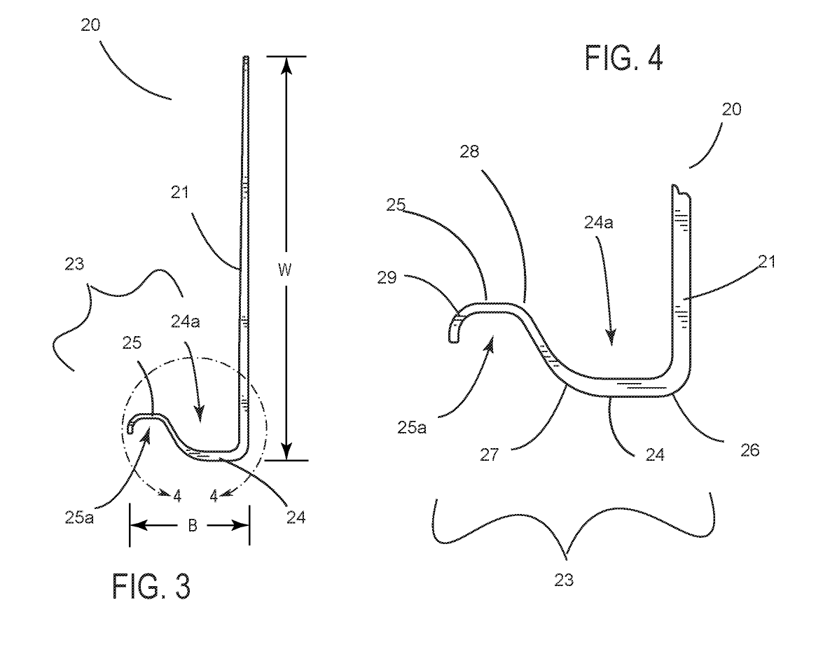

in accordance with various embodiments and as illustrated in FIGS. 3-4, the extension 23 may be cantilevered from one edge of the backer 21. As shown in the exemplary embodiments of FIGS. 3-4, the extension may extend from the backer 21 in a nonlinear manner as viewed from the side (i.e., in profile). For example, in profile, the extension may form a serpentine shape. In accordance with embodiments, the extension may extend in a linear manner as viewed from the side (i.e., in profile). The extension 23 may extend from the backer 21 a distance of B. In various examples, the backer 21 may have a height of distance W. The distance B may be greater than ⅕ W. The distance B may be less than ½ W. In one example, the distance W may be about 3.5 times the distance B.

The extension 23 may include a plurality of separate segments that form the general path of the extension 23 profile. For example, the extension 23 may include a wall 24 that extends from one edge of backer 21 and is generally perpendicular to the backer 21. The wall 24 may also extend at various angles other than 90° including angles greater than and less than 90°. The wall 24 may be connected to backer 21 along a first edge via a first round 26. The first round 26 may curve from the backer 21 into a substantially rectilinear portion (as viewed from the side) forming the wall 24. In other embodiments, the wall 24 may be generally curvilinear (viewed from the side). The wall 24 may also include a return wall 27. The return wall 27 may curve from the wall 24 in the same direction as the backer 21, forming a recess 24a between the return wall 27 and the backer 21 with the wall 24 at its base. The recess 24a may form a concave channel that extends at least a portion of the distance across the backer 21. The concave channel may face in a direction across the front of the backer 21. The recess 24a may be at least large enough in size to receive the ends of a user's fingers and strong enough to manipulate the access panel 5 on a vehicle.

The extension 23 may also include a wall 25. The wall 25 may be sized such that a user is able to engage the user's fingers on the wall 25 in order to apply a sufficient force to manipulate the trunk lid. The wall 25 may be connected to the first wall 24. In various examples, the wall 25 and the wall 24 may extend in generally the same direction. For example, the walls 24, 25 may be parallel. In other examples, each wall may be curvilinear. In various examples, the walls 24, 25 may extend in different directions. The wall 25 may connect to wall 24 via the return wall 27. The wall 25 may also include a return lip 29. The return lip 29 may extend away from the wall 25 in generally the same direction from which return wall 27 extends away from wall 25 such that the return lip 29, the return wall 27, and the wall 25 form a recess 25a. The recess 25a may define a concave channel extending across a portion of the backer 21. The concavity of recess 25a may face in the opposite direction as the concavity of recess 24a.

As illustrated in FIGS. 3-4, the first recess 24a and the second recess 25a are positioned in opposite directions such that the first recess 24a can receive a user's fingers on one side of the extension 23 and the second recess 25a can receive a user's fingers on the other side of the extension 23. This relative position between the recess 24a and the recess 25a allows the bracket 20 to be located in positions that locate the extension 23 either above or below the license plate, as the recesses allow finger access into a recess from the same direction in either position. This relative position also allows a user to manipulate the access panel 5 of a vehicle in multiple directions. For example, a user may pull down on the bracket 20 (pulling the access panel 5 down) with the extension 23 located above the license plate 30 by inserting the user's fingers into recess 25a. Similarly, the user can pull up on the bracket 20 (pulling up the access panel 5) with the extension 23 located above the license plate 30 by inserting the user's fingers into recess 24a. Conversely, with the extension 23 located below the license plate 30, the user can pull down on the bracket 20 (pulling down the access panel 5) by inserting fingers in the recess 24a, and the user can pull up on the bracket 20 (pulling up the access panel 5) by inserting the user's fingers in the recess 25a.

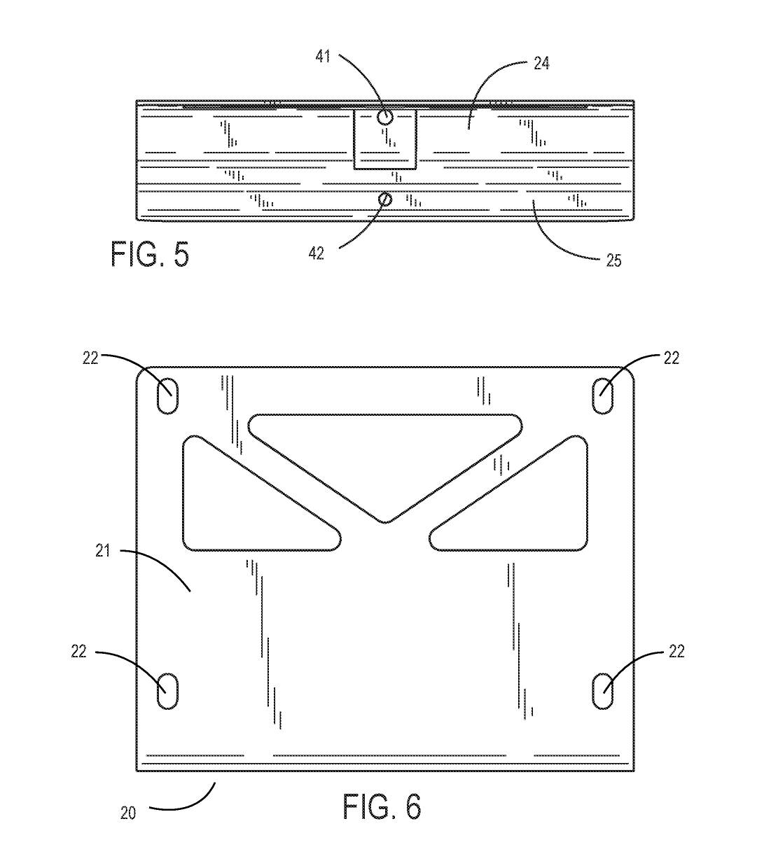

In accordance with various embodiments, the recess 24a and the recess 25a may have features operable to shed water. For example, as illustrated in FIG. 5, the wall 24 may include an aperture 41 that extends through the wall. The aperture 41 may be sized such that water easily drains from the first recess 24a. Similarly, the wall 25 may include an aperture 42 that extends through the wall. The aperture 42 may be sized such that water easily drains from the first recess 25a. The first recess 24a and or the second recess 25a may also be tapered inwardly so that when the concavity of the recess faces upward, water will run to the center of the upward facing recess and drain through the aperture 41. Other structures may also or alternatively be included to drain water. For example, one or both of the recesses 24a, 25a may slope outwardly from the center of bracket 20 such that when the concavity of either recess 24a or 25a faces upward, any water caught therein will shed to the sides of bracket 20.

In accordance with the various embodiments described herein, the bracket 20 may be manufactured by any known technique including injection molding, stamping, forming, casting, machining, high speed manufacturing techniques, or any other similar process. The bracket 20 may also be made of any available materials including metal, polymer, wood, elastomers, etc., or composites of the same. For example, the product may be made with polycarbonate material. The polycarbonate material may be sufficiently flexible and strong to handle the consistent manipulation of the access panel 5. in some embodiments the material may be clear or translucent. A clear or translucent material may limit visual obstruction of the license plate, license plate frame, or the aesthetic appeal of the access panel 5 and/or its associated paint schemes or hardware. In other embodiments, the material may be opaque. For example, the material may be colored to match the paint on the vehicle.

In accordance with various embodiments, the bracket 20 may be made as one or more parts. For example, in manufacturing, the extension 23 may be contiguously formed with the backer 21. In other embodiments, the backer 21 and the extension 23 may be formed separately and then mechanically attached together. As indicated above, the backer 21 can take numerous forms. For example, the backer 21 may be made of multiple parts. In embodiments in which the back also forms the frame of the license plate, the backer could have a bezel, a rear bracket, and or other components that are mechanically attached together. The extension could be separately formed from any of these parts or contiguously formed with them.

Any and all references specifically identified in the specification of the present application are expressly incorporated herein in their entirety by reference thereto. The term “about,” as used herein, should generally be understood to refer to both the corresponding number and a range of numbers. Moreover, all numerical ranges herein should be understood to include each whole integer within the range.

All relative and directional references (including: upper, lower, upward, downward, left, right, leftward, rightward, top, bottom, side, above, below, front, middle, back, vertical, horizontal, height, depth, width, and so forth) are given by way of example to aid in understanding of the particular embodiments described herein. They should not be interpreted to be requirements or limitations, particularly as to the position, orientation, or use of the invention unless specifically set forth in the claims. Connection references (e.g., attached, coupled, connected, joined, and the like) are to be construed broadly and may include intermediate members between a connection of elements and relative movement between elements. As such, connection references do not necessarily infer that two elements are directly connected and in fixed relation to each other, unless specifically set forth in the claims.

While illustrative embodiments of the invention are disclosed herein, it will be appreciated that numerous modifications and other embodiments may be devised by those skilled in the art. For example, the features for the various embodiments can be used in other embodiments. Therefore, it will be understood that the appended claims are intended to cover all such modifications and embodiments that come within the spirit and scope of the present invention.

1. A bracket configured for attaching a license plate to a vehicle trunk lid, the bracket comprising:
a backer comprising a front surface configured to receive the license plate and a back surface configured to mount onto the vehicle trunk lid; and
an extension attached to, and pointing outwardly from, the backer a beyond a thickness of the license plate to define a lip configured to receive a lifting force or a closing force from.

2. The bracket of claim 1, wherein the extension is contiguously formed with the backer.

3. The bracket of claim 1, wherein the extension is cantilevered from one edge of the backer.

4. The bracket of claim 1, wherein the extension comprises a wall sized to engage the user's fingers on the wall and receive the lifting force or the closing force.

5. The bracket of claim 4, wherein the wall is oblique to or perpendicular to the backer.

6. The bracket of claim 4, wherein the wall defines a portion of a concave recess that at least partially defines the lip.

7. The bracket of claim 6, wherein:
the wall is a first wall; and
the extension includes a second wall that at least partially defines the lip.

8. The bracket of claim 7, wherein the second wall is contiguously formed with the first wall.

9. The bracket of claim 8, wherein the second wall is oblique to or perpendicular to the backer.

10. The bracket of claim 8, wherein the second wall defines a portion of a second recess that is concave in the opposite direction of the concavity of the first recess.

11. The bracket of claim 10, wherein the second wall includes a return lip that forms a portion of the second recess.

12. The bracket of claim 10, wherein the first recess and the second recess are positioned in opposite directions such that the first recess is configured to receive the user's fingers on one side of the extension and the second recess is configured to receive the user's finger on the other side of the extension.

13. The bracket of claim 7, wherein the first wall defines a drain aperture configured to drain water from the first recess.

14. The bracket of claim 13, wherein the first wall is sloped toward the drain aperture to direct water toward the drain aperture.

15. The bracket of claim 14, wherein:
the drain aperture is a first drain aperture; and
the second wall defines a second drain aperture configured to drain water from the second recess.

16. The bracket of claim 1, further comprising one or more connection elements positioned on the backer and configured to position the license plate relative to the backer.

17. The bracket of claim 16, wherein the extension is positioned relative to the one or more connection elements such that the license plate is positionable either above or below the extension.

18. The bracket of claim 16, wherein the one or more connection elements are defined by a plurality of apertures each configured to receive a fastener.

19. The bracket of claim 1, wherein the backer and the extension are formed from a polycarbonate material.

20. The bracket of claim 19, wherein the polycarbonate material is clear or translucent such that the backer and the extension have limited visual obstruction of the license plate, license plate frame, or the vehicle trunk lid.
